(19) United States
(12) Patent Application Publication
(10) Pub. No.: US 2011/0140624 A1
(43) Pub. Date: Jun. 16, 2011

(54) CIRCUIT AND METHOD FOR OPERATING A HIGH PRESSURE LAMP

(75) Inventor: Marcus Cornelis Van Meel, Helmond (NL)

(73) Assignee: KONINKLIJKE PHILIPS ELECTRONICS N.V., EINDHOVEN (NL)

(21) Appl. No.: 13/059,083

(22) PCT Filed: Aug. 18, 2009
(86) PCT No.: PCT/IB09/53642

§ 371 Date: Feb. 15, 2011

(30) Foreign Application Priority Data
Aug. 19, 2008 (EP) 08162570.9

(51) Int. Cl. H05B 41/16

(52) U.S. Cl. 315/246

(57) ABSTRACT

The invention relates to a circuit for operating a high pressure discharge lamp La. The circuit comprises input terminals for connecting to a source of supply voltage; first capacitive means C1 coupled to the input terminals and second capacitive means C2 coupled to the input terminals parallel to the first capacitive means C1. A switchable element D1 is provided between the first and second capacitive means C1, C2 for blocking a current with which the second capacitive means C2 in use charge the first capacitive means C1. Output terminals for connection of the high pressure discharge lamp La and the inductive means are provided and a commutator BR coupled to said input terminal and to said output terminals for supplying an alternating current to the high pressure discharge lamp La when the lamp is connected to said output terminals. The circuit comprises a pulse supply for supplying to the output terminals a current pulse in a later part of a half period of the alternating current.

### FIELD OF THE INVENTION

The present invention relates to a circuit and method for operating a high pressure discharge lamp. The circuit and method may for example be used for high pressure discharge lamps used in the automotive industry.

### BACKGROUND OF THE INVENTION

A circuit arrangement for operating a high-pressure discharge lamp is disclosed in WO 98/10624. The circuit arrangement is provided with a first capacitive means and a commutator for generating a low-frequency alternating current through the high-pressure discharge lamp from a DC voltage present across the first capacitive means. The commutator comprises input terminals coupled to the first capacitive means and a load branch which comprises terminals for connection of the high-pressure discharge lamp and inductive means. The first capacitive means are shunted by a branch K, which comprises a series circuit of second capacitive means and a uni-directional element for blocking a current with which the second capacitive means charge the first capacitive means.

The voltage pulse that may be created on the second capacitive means is for a large part dependent on the current in the inductive means.

### OBJECT OF THE INVENTION

It is an object of the invention to provide an improved circuit in which the voltage pulse is better controlled or an alternative for the above mentioned circuit.

### SUMMARY OF THE INVENTION

According to an embodiment of the invention there is provided a circuit for operating a high pressure discharge lamp comprising:

input terminals for connecting to a source of supply voltage;

first capacitive means coupled to the input terminals;

second capacitive means coupled to the input terminals parallel to the first capacitive means and;

a switchable element between the first and second capacitive means for blocking a current with which the second capacitive means in use charge the first capacitive means;

output terminals for connection of the high pressure discharge lamp and an inductive means;

a commutator coupled to said input terminals and to said output terminals for supplying an alternating current to the high pressure discharge lamp when the lamp is connected to said output terminals; wherein the circuit comprises a pulse supply for supplying to the output terminals a current pulse in a later part of a half period of the alternating current.

By supplying a current pulse with the pulse supply in a later part of a half period of the alternating current the current in the inductive means just before the commutator switches the current can be controlled. The current in the inductive means just before commutation determines the voltage pulse on the second capacitive means and by controlling the current with the current pulse the voltage pulse can be controlled during commutation. It is advantageous to control the voltage pulse because it has an important role in the re-ignition of the high pressure discharge lamp.

According to an embodiment of the invention the pulse supply is constructed and arranged for supplying a current pulse in the same direction as the alternating current. The extra current just before commutation may generate a voltage pulse on the high pressure discharge lamp which helps the lamp to commutate and may circumvent flickering of the lamp.

According to an embodiment of the invention the pulse supply is constructed and arranged for supplying a current pulse in opposite direction as the alternating current. The result will be a smaller current in the inductive means and a smaller voltage pulse on the second capacitive means. This may be helpful in the run-up phase when the current in the lamp may already be higher than during normal operation of the lamp to start the lamp. A pulse in the opposite direction just before commutation may limit the voltage pulse on the commutator. With the higher currents in the run-up phase the commutator may be damaged by the very large voltage pulse on the commutator.

The circuit may comprise a controller for synchronizing the alternating current of the commutator with the pulse of the pulse supply. The pulse will be synchronized so that the current pulse will flow in a later part of a half period of the alternating current to have an effect on the inductive means. The controller may control the switchable element, which for example may be a field effect transmitter (FET). The controller may be constructed and arranged to control the switch so as to divide the charge on the first and second capacitive means as pre-programmed on a programmable memory provided to the controller. The switchable element may be a diode which can be switched between a closed and an open state depending on the direction of the current.

According to a further embodiment of the invention there is provided a method for operating a high pressure discharge lamp comprising:

supplying a supply voltage to input terminals of a circuit;

charging a first capacitive means coupled to the input terminals;

charging a second capacitive means coupled to the input terminals parallel to the first capacitive means;

blocking a current with which the second capacitive means in use charge the first capacitive means;

switching with a commutator between the poles of the input terminal to supply an alternating current to the output terminal for connecting the high pressure discharge lamp and an inductive means; wherein a pulse is provided in a later part of a half period of the alternating current.

These and other aspects of the invention will be apparent from and elucidated with reference to the embodiments described hereinafter.

### BRIEF DESCRIPTION OF THE DRAWINGS

Embodiments of the invention will be explained in more detail with reference to the drawings, in which:

FIG. 1 depicts a circuit diagram of the circuit for operating a high pressure discharge lamp according to the invention;

FIG. 2a-c depict diagrams showing the currents and the signals in a circuit diagram for operating the high pressure discharge lamp.

FIG. 3a-c depict diagrams showing the currents and the signals in a circuit diagram for operating the high pressure discharge lamp according to an embodiment of the invention.

FIG. 4a-c depict diagrams showing the currents and the signals in a circuit diagram for operating the high pressure discharge lamp according to a further embodiment of the invention.

### DETAILED DESCRIPTION OF EXAMPLES

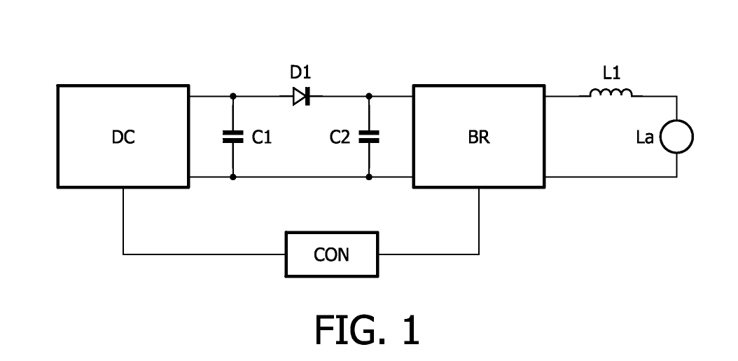

FIG. 1 depicts a circuit diagram of the circuit for operating the high pressure discharge lamp according to the invention. The circuit diagram includes an inductor and high pressure discharge lamp, however the circuit, inductor and lamp may also be supplied as separate units.

A DC-DC converter DC provides a DC current on the input terminal of the circuit and may be adjustable to provide the right current for operation of the circuit. The input terminal is coupled to a first and second capacitor C1, C2. C2 may be smaller than C1, for example C2 may be a factor 10 smaller than C1. Good results have been obtained with C1 being 470 nF and C2 being 22 nF or 47 nF. As an alternative for the capacitors any electrical storage such as a battery may be used as the capacitive means, however capacitors may be preferred because of their simplicity. Between the capacitors a diode D1 is coupled in the circuit. The input terminal is further coupled to a commutator BR (commutation bridge) for making an AC current which via the inductor L1 is provided to the high pressure discharge lamp La. The commutator BR may for example comprise four field effect transistors (FETs). Two of the FETs may be opened while another two may be closed. By opening the closed FETs and closing the opened FETs an alternating current may be generated on the output terminal. The controller Con provides a signal to the commutator BR for timing of the commutation of the AC current. The controller Con is also connected to the DC-DC converter DC so as to synchronize a current pulse that the DC-DC converter DC may gave on the input terminal with the commutation of the transistor BR. The current pulse may be timed so that it will occur just before the commutation so that the current pulse will result in a voltage pulse by the inductor L1 during commutation.

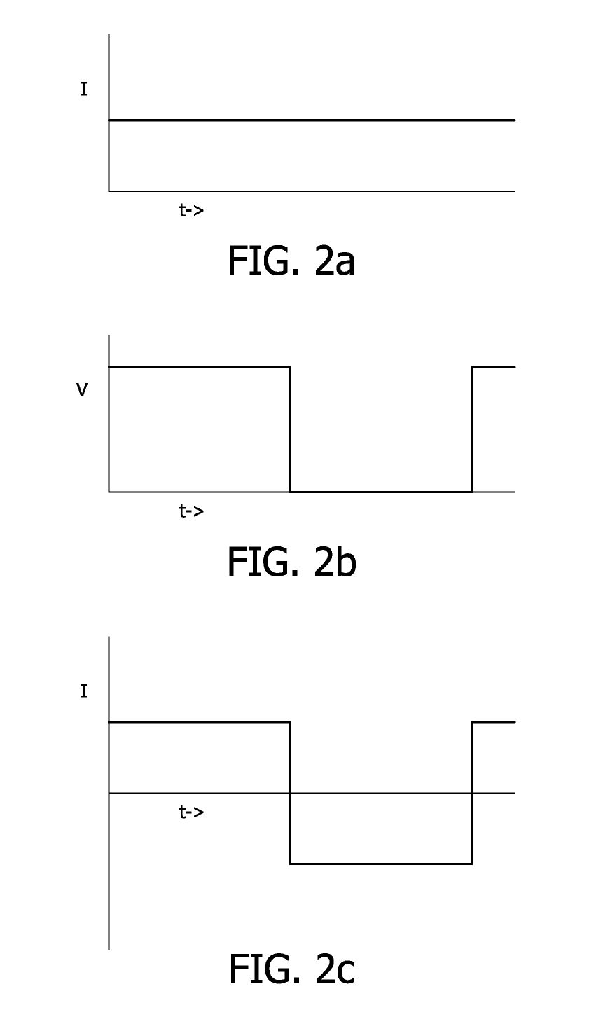

A more detailed circuit diagram of the controller is published in U.S. Pat. No. 5,608,294 incorporated herein by reference. FIG. 2 of U.S. Pat. No. 5,608,294 discloses a means III which may provide a control signal for the commutator BR and at the same time a synchronized signal to control the current pulse of the DC-DC converter DC via a driver circuit to generate a current pulse on the output terminal.

FIG. 2a-c depict diagrams showing the currents and the signals in a circuit diagram for operating the high pressure discharge lamp. FIG. 2a shows the constant current that a DC converter may deliver on the input terminals of the circuit as a function of time. FIG. 2b discloses the signal that the controller Con may provide to the commutator BR as a function of time. The signal alternates between a high and a low (zero signal) voltage which will control the commutator to alternate the DC current to generate an AC current. The resulting alternating lamp current is shown in FIG. 2c.

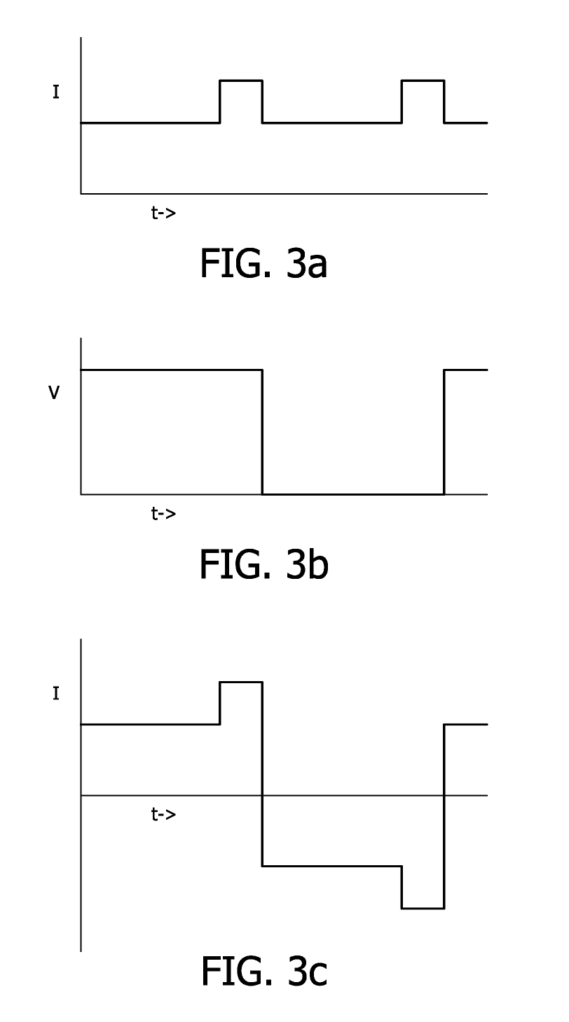

FIG. 3a-c depict diagrams showing the currents and the signals in a circuit diagram for operating the high pressure discharge lamp according to an embodiment of the invention. FIG. 3a shows the constant current that a DC converter may deliver on the input terminals of the circuit as a function of time. The current is constant except for the positive current pulse that is generated by the DC-DC converter. FIG. 3b discloses the signal that the controller Con may provide to the commutator BR as a function of time. The signal is not being changed with respect to the signal of FIG. 2b. The resulting alternating lamp current with a current pulse before commutation is shown in FIG. 3c. The current pulse results in a higher current in the lamp just before commutation which leads via the inductor L to a higher voltage pulse which is stored in the second capacitor. The higher voltage pulse is advantageous in the re-ignition of the high pressure discharge lamp. A high voltage pulse during commutation may circumvent flickering of the lamp. For older lamps where the lamp voltage is higher and the lamp current lower than new lamp this is also advantageous because the older lamp needs a higher voltage pulse for the re-ignition, which now may be generated.

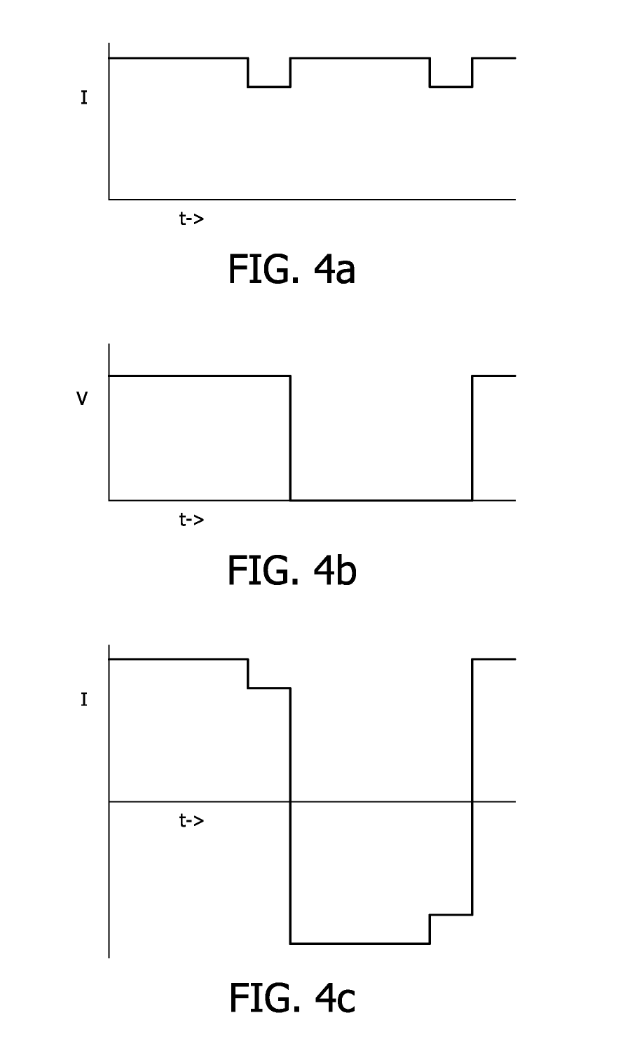

FIG. 4a-c depict diagrams showing the currents and the signals in a circuit diagram for operating the high pressure discharge lamp according to a further embodiment of the invention. FIG. 4a shows the constant current that a DC converter may deliver on the input terminal of the circuit as a function of time. The current is constant except for the negative current pulse that is generated by the DC-DC converter. FIG. 4b discloses the signal that the controller Con may provide to the commutator BR as a function of time. The signal is not being changed with respect to the signal of FIG. 2b. The resulting alternating lamp current with a negative current pulse before commutation is shown in FIG. 4c. The current pulse results in a lower current in the lamp just before commutation which leads via the inductor L to a lower voltage pulse which is stored in the second capacitor. The lower voltage pulse may be advantageous during the run-up phase of the lamp. During run-up the lamp current may be much higher than during normal operation. The higher run-up current may via the inductor L1 and the capacitor C2 generate a very high voltage pulse on the commutator. In practice, the voltage pulse during run-up may be so high that the commutator may get damaged. The negative current pulse may circumvent damaging of the commutator during run-up.

The idea of a positive pulse and a negative pulse can also be combined by choosing a constant pulse. For example, the optimal run-up current of a lamp may be 4 A and the normal operation current of the lamp may be 1 A. The constant current pulse may be chosen to be 2 A so that during run up a negative current pulse of 2 A is necessary and during normal operation a positive pulse of 1 A is necessary to have a 2 A current. During run-up the negative current pulse protects the commutator and during normal operation the positive current pulse circumvents flickering of the lamp.

As an alternative one could adjust the current pulse in a later part of a half period of the alternating current independently with an adjustment controller. The adjustment controller could dependent on the age of the lamp make the positive current pulse higher since older lamps have more difficulties to re-ignite. The adjustment controller could also give a higher positive current pulse if the lamp is dimmed because the chance of flickering increases during dimming of the lamp.

As a further alternative one could use a switchable element such as for example a field emission transmitter FET. The FET would replace the diode D1 in FIG. 1 and may control the distribution of the voltage pulse over the second and first capacitor. For example, during run-up when the current is higher than the current during normal operation there is a risk of damaging the switchable transmitter with a too high voltage pulse. If the FET is in a closed state the current will go through the FET and the voltage pulse will be distributed over both capacitors and this will limit the voltage pulse and protect the commutator without using a negative current pulse. This may be pre-programmed in a memory provided to the controller.

1. A circuit for operating a high pressure discharge lamp comprising:
input terminals for connecting to a source of supply voltage;
first capacitive means coupled to the input terminals;
second capacitive means coupled to the input terminals parallel to the first capacitive means and;
a switchable element between the first and second capacitive means for blocking a current with which the second capacitive means in use charge the first capacitive means;
output terminals for connecting the high pressure discharge lamp and an inductive means;
a commutator coupled to said input terminals and to said output terminals for supplying an alternating current to the high pressure discharge lamp when the lamp is connected to said output terminals; wherein the circuit comprises a
a pulse supply for supplying to the output terminals a current pulse in a later part of a half period of the alternating current.

2. The circuit according to claim 1, wherein the pulse supply is constructed and arranged for supplying a current pulse in the same direction as the alternating current.

3. The circuit according to claim 1, wherein the pulse supply is constructed and arranged for supplying a current pulse in opposite direction as the alternating current.

4. The circuit according to claim 1, wherein the switchable element is a diode which can be switched between a closed and an open state depending on the direction of the current.

5. The circuit according to claim 1, wherein the circuit comprises a controller for synchronizing the alternating current of the commutator with the pulse of the pulse supply.

6. The circuit according to claim 5 wherein the switchable element is controllable with the controller.

7. The circuit according to claim 6, wherein the switchable element is a field effect transmitter (FET).

8. The circuit according to claim 6, wherein the controller is constructed and arranged to control the switchable element so as to divide the charge on the first and second capacitive means as pre-programmed on a programmable memory provided to the controller.

9. The circuit according to claim 1, wherein the capacitive means are capacitors and the second capacitive means has a smaller capacity than the first capacitive means.

10. A method for operating a high pressure discharge lamp comprising:
supplying a supply voltage to input terminals of a circuit;
charging a first capacitive means coupled to the input terminals;
charging a second capacitive means coupled to the input terminals parallel to the first capacitive means;
blocking a current with which the second capacitive means in use charge the first capacitive means with a switchable element between the first and second capacitive means;
switching with a commutator between the poles of the input terminal to supply an alternating current to the output terminal for connecting the high pressure discharge lamp and an inductive means; wherein a pulse is provided in a later part of a half period of the alternating current.

11. The method according to claim 10, wherein the switchable element is closed during run-up of the lamp so that the second capacitive means may charge the first capacitive means.
